(19) United States
(12) Patent Application Publication
(10) Pub. No.: US 2012/0299676 A1
(43) Pub. Date: Nov. 29, 2012

(54) CORROSION-RESISTANT MAGNET AND METHOD FOR PRODUCING THE SAME

(75) Inventors: Toshinobu Niinae, Saitama (JP); Koshi Yoshimura, Osaka (JP); Koji Kamiyama, Hyogo (JP)

(73) Assignee: HITACHI METALS, LTD., TOKYO (JP)

(21) Appl. No.: 13/516,798

(22) PCT Filed: Dec. 28, 2010
(86) PCT No.: PCT/JP2010/073675

§ 371 Date: Jul. 31, 2012

(30) Foreign Application Priority Data
Dec. 28, 2009 (JP) 2009-297153

(51) Int. Cl. H01F 1/053; C23C 22/05

(52) U.S. Cl. 335/302; 148/240; 148/247

(57) ABSTRACT

An object of the present invention is to provide an R—Fe—B based sintered magnet having on a surface thereof a chemical conversion film with higher corrosion resistance than a conventional chemical conversion film such as a phosphate film, and a method for producing the same. The R—Fe—B based sintered magnet having a chemical conversion film on the surface thereof of the present invention as a means for achieving the object is characterized by comprising a chemical conversion film on a surface of an R—Fe—B based sintered magnet wherein R is a rare-earth element including at least Nd, the chemical conversion film having a laminate structure including at least an inner layer that contains R, fluorine, and oxygen as constituent elements and an outer layer that is amorphous and contains Zr, Fe, and oxygen as constituent elements, provided that no phosphorus is contained in the film.

### TECHNICAL FIELD

The present invention relates to an R—Fe—B based sintered magnet with corrosion resistance and also to a method for producing the same.

### BACKGROUND ART

Nowadays, R—Fe—B based sintered magnets represented by Nd—Fe—B based sintered magnets have been used in various fields for their high magnetic characteristics. However, an R—Fe—B based sintered magnet contains a highly reactive rare-earth element: R, and thus is susceptible to oxidization and corrosion in air. Therefore, when such a magnet is used without a surface treatment, corrosion proceeds from the surface due to the presence of small amounts of acids, alkalis, water, etc., whereby rust occurs, causing deterioration or fluctuation in the magnetic characteristics. Further, when such a rusted magnet is incorporated into a device such as a magnetic circuit, the rust may be dispersed and contaminate peripheral parts.

Various methods are known for imparting corrosion resistance to an R—Fe—B based sintered magnet. One of them is a method in which a surface of the magnet is subjected to chemical conversion treatment to form a chemical conversion film. For example, Patent Document 1 describes a method in which a phosphate film is formed as a chemical conversion film on the magnet surface. This method has been widely employed as a simple rust-prevention method for easily imparting necessary corrosion resistance to a magnet.

### PRIOR ART DOCUMENTS

### Patent Documents

Patent Document 1: JP-B-4-22008

### SUMMARY OF THE INVENTION

### Problems to be Solved by the Invention

However, a method as described in Patent Document 1, in which a chemical conversion film is directly formed on the surface of an R—Fe—B based sintered magnet, does not go beyond conventional, simple rust-prevention methods, and is likely to cause the shedding of magnetic particles in an environment that promotes corrosion. In addition, the magnet may crack due to external stress. Accordingly, there has been a demand for the development of a method for forming a chemical conversion film with improved corrosion resistance.

Thus, the present invention is aimed to provide an R—Fe—B based sintered magnet having on a surface thereof a chemical conversion film with higher corrosion resistance than a conventional chemical conversion film such as a phosphate film, more specifically a chemical conversion film capable of preventing the shedding of magnetic particles even when subjected to a corrosion resistance test such as a pressure cooker test. The present invention is also aimed to provide a method for producing the same.

### Means for Solving the Problems

A corrosion-resistant magnet of the present invention accomplished in light of the above points is, as defined in claim 1, characterized by comprising a chemical conversion film on a surface of an R—Fe—B based sintered magnet wherein R is a rare-earth element including at least Nd, the chemical conversion film having a laminate structure including at least an inner layer that contains R, fluorine, and oxygen as constituent elements and an outer layer that is amorphous and contains Zr, Fe, and oxygen as constituent elements, provided that no phosphorus is contained in the film.

A corrosion-resistant magnet as defined in claim 2 is characterized in that in the corrosion-resistant magnet according to claim 1, the inner layer has a fluorine content of 1 at % to 20 at %.

A corrosion-resistant magnet as defined in claim 3 is characterized in that in the corrosion-resistant magnet according to claim 1, the outer layer has a Zr content of 5 at % to 60 at %.

A corrosion-resistant magnet as defined in claim 4 is characterized in that in the corrosion-resistant magnet according to claim 1, the inner layer further contains Fe as a constituent element.

A corrosion-resistant magnet as defined in claim 5 is characterized in that in the corrosion-resistant magnet according to claim 1, the outer layer further contains R as a constituent element.

A corrosion-resistant magnet as defined in claim 6 is characterized in that in the corrosion-resistant magnet according to claim 1, the chemical conversion film has a thickness of 10 nm to 200 nm.

A corrosion-resistant magnet as defined in claim 7 is characterized in that in the corrosion-resistant magnet according to claim 1, the inner layer has a thickness of 2 nm to 70 nm.

A corrosion-resistant magnet as defined in claim 8 is characterized in that in the corrosion-resistant magnet according to claim 1, the outer layer has a thickness of 5 nm to 100 nm.

A corrosion-resistant magnet as defined in claim 9 is characterized by, in the corrosion-resistant magnet according to claim 1, containing an intermediate layer between the inner layer and the outer layer.

A corrosion-resistant magnet as defined in claim 10 is characterized by, in the corrosion-resistant magnet according to claim 1, having a resin film on a surface of the chemical conversion film.

A corrosion-resistant magnet as defined in claim 11 is characterized in that in the corrosion-resistant magnet according to claim 1, the surface of the magnet has a layer made of a compound containing R and oxygen.

A method for producing a corrosion-resistant magnet of the present invention is, as defined in claim 12, characterized in that a chemical conversion film is formed on a surface of an R—Fe—B based sintered magnet wherein R is a rare-earth element including at least Nd, the chemical conversion film having a laminate structure including at least an inner layer that contains R, fluorine, and oxygen as constituent elements and an outer layer that is amorphous and contains Zr, Fe, and oxygen as constituent elements, provided that no phosphorus is contained in the film.

A production method as defined in claim 13 is characterized in that in the production method according to claim 12, the magnet is immersed in an aqueous solution containing at least Zr and fluorine, and the magnet is oscillated up and down and/or from side to side in the solution.

A production method as defined in claim 14 is characterized in that in the production method according to claim 12, the magnet is subjected to a heat treatment at a temperature range of 450° C. to 900° C., and the chemical conversion film is formed thereafter.

A production method as defined in claim 15 is characterized in that in the production method according to claim 14, the heat treatment is performed with the magnet being housed in a heat-resistant box.

### Effect of the Invention

The present invention enables the provision of an R—Fe—B based sintered magnet having on a surface thereof a chemical conversion film with higher corrosion resistance than a conventional chemical conversion film such as a phosphate film, and a method for producing the same.

### BRIEF DESCRIPTION OF THE DRAWINGS

FIG. 1 A photograph of a cross-section above a main phase in Example 1.

FIG. 2 Similarly, a photograph of a cross-section above a grain boundary phase.

FIG. 3 Similarly, electron diffraction images of an outer layer of a chemical conversion film formed on the main phase and an outer layer of a chemical conversion film formed on the grain boundary phase.

FIG. 4 A photograph of a cross-section above a heat-treatment layer in Example 4.

FIG. 5 Similarly, an electron diffraction image of an outer layer of a chemical conversion film formed on the heat-treatment layer.

### MODE FOR CARRYING OUT THE INVENTION

A corrosion-resistant magnet of the present invention is characterized by comprising a chemical conversion film on a surface of an R—Fe—B based sintered magnet wherein R is a rare-earth element including at least Nd, the chemical conversion film has a laminate structure including at least an inner layer that contains R, fluorine, and oxygen as constituent elements and an outer layer that is amorphous and contains Zr, Fe, and oxygen as constituent elements, provided that no phosphorus is contained in the film. Hereinafter, the R—Fe—B based sintered magnet wherein R is a rare-earth element including at least Nd is sometimes referred to simply as “R—Fe—B based sintered magnet” or “magnet”.

The R—Fe—B based sintered magnet to be treated in the present invention, wherein R is a rare-earth element including at least Nd, may be a product at the stage where it has undergone a surface working, such as cutting or grinding, and thus has been adjusted to a shape of a predetermined size, for example.

As a method for forming a chemical conversion film having a laminate structure including at least an inner layer that contains R, fluorine, and oxygen as constituent elements and an outer layer that is amorphous and contains Zr, Fe, and oxygen as constituent elements (provided that no phosphorus is contained in the film) on the surface of the R—Fe—B based sintered magnet wherein R is a rare-earth element including at least Nd, for example, a method in which an aqueous solution containing at least Zr and fluorine is applied as a treatment liquid to the surface of the magnet, followed by drying, is mentioned. A specific example of the treatment liquid is one prepared by dissolving a compound containing Zr and fluorine, such as fluorozirconic acid (H₂ZrF₆), or an alkali metal salt, an alkaline earth metal salt, or an ammonium salt of fluorozirconic acid, in water (hydrofluoric acid or the like may be further added). The Zr content of the treatment liquid is preferably 1 ppm to 2000 ppm, and more preferably 10 ppm to 1000 ppm, as metal. This is because when the content is less than 1 ppm, a chemical conversion film may not be formed, while a content of more than 2000 ppm may increase the cost. The fluorine content of the treatment liquid is preferably 10 ppm to 10000 ppm, and more preferably 50 ppm to 5000 ppm, as fluorine concentration. This is because when the content is less than 10 ppm, the surface of the magnet may not be efficiently etched, while a content of more than 10000 ppm may result in an etching rate higher than the rate of film formation, making it difficult to form a uniform film. The treatment liquid may also be prepared by dissolving a fluorine-free Zr compound, such as zirconium tetrachloride, or a sulfate or nitrate of Zr, and a Zr-free fluorine compound, such as hydrofluoric acid, ammonium fluoride, ammonium hydrogen fluoride, sodium fluoride, or sodium hydrogen fluoride, in water. The treatment liquid may or may not have sources of R and Fe, constituent elements of the chemical conversion film. This is because as the surface of the R—Fe—B based sintered magnet wherein R is a rare-earth element including at least Nd is etched in the course of the chemical conversion treatment, these elements are eluted from the magnet and incorporated into the chemical conversion film. The pH of the treatment liquid is preferably adjusted to 1 to 6. This is because when the pH is less than 1, the surface of the magnet may be excessively etched, while a pH of more than 6 may affect the stability of the treatment liquid.

For the purpose of improving the reactivity in the chemical conversion treatment, improving the stability of the treatment liquid, improving the adherence between the chemical conversion film and the surface of the magnet, improving the adhesiveness with an adhesive used for the incorporation of the magnet into a part, etc., the treatment liquid may also contain, in addition to the above components, organic acids such as tannic acid, oxidizing agents (hydrogen peroxide, chloric acid and salts thereof, nitrous acid and salts thereof, nitric acid and salts thereof, tungstic acid and salts thereof, molybdenum acid and salts thereof, etc.), water-soluble resins such as water-soluble polyamide and polyallylamine, etc.

In the case where the treatment liquid itself lacks storage stability, such a treatment liquid may be prepared when needed. An example of a commercially available treatment liquid usable in the present invention is PALLUCID 1000 (trade name) prepared from PALLUCID 1000MA and AD-4990 manufactured by Nihon Parkerizing Co., Ltd.

As a method for applying the treatment liquid to the surface of the R—Fe—B based sintered magnet, immersion, spraying, spin coating, or the like can be employed. Upon application, the temperature of the treatment liquid is preferably 20° C. to 80° C. This is because when the temperature is less than 20° C., the reaction may not proceed, while a temperature of more than 80° C. may affect the stability of the treatment liquid. The treatment time is usually 10 seconds to 10 minutes. In the case where immersion is employed as the application method, in order to form a chemical conversion film uniformly on the surface of the magnet, it is preferable that the magnet is oscillated up and down and/or from side to side in the liquid so that a fresh treatment liquid is constantly supplied to the surface of the magnet. It is preferable that the amplitude of the oscillation is 3 cm to 8 cm, for example, and also that the oscillation is stopped for 3 seconds to 20 seconds, for example, at each end position. The oscillation of the magnet in the liquid may be performed by oscillating the magnet itself in the liquid bath or by oscillating the liquid bath relative to the magnet.

After the treatment liquid is applied to the surface of the magnet, a drying treatment is performed. When the temperature of the drying treatment is less than 50° C., sufficient drying cannot be achieved, and this may degrade the appearance or affect the adhesiveness with an adhesive used for the incorporation of the magnet into a part. When the temperature is more than 250° C., this may cause decomposition of the formed chemical conversion film. Therefore, the temperature is preferably 50° C. to 250° C. In terms of productivity and production cost, a temperature of 50° C. to 200° C. is more preferable. The drying treatment time is usually 5 seconds to 1 hour. In order to form a chemical conversion film uniformly on the surface of the magnet, it is preferable that the magnet is washed with hot water at 50° C. to 70° C. before the drying treatment. After washing, in terms of preventing the magnet from corrosion, etc., it is preferable that water droplets on the surface of the magnet are removed with an air blower or the like.

The corrosion-resistant magnet of the present invention may be a corrosion-resistant magnet obtained, without any special artificial pre-processing of an R—Fe—B based sintered magnet to be treated (wherein R is a rare-earth element including at least Nd), by forming a predetermined chemical conversion film on the surface thereof. Alternatively, it may also be a corrosion-resistant magnet obtained by subjecting a magnet to be treated to a predetermined heat treatment and then forming a predetermined chemical conversion film on the surface thereof. A corrosion resistance test, such as a pressure cooker test, on an R—Fe—B based sintered magnet having on the surface thereof a conventional chemical conversion film such as a phosphate film is accompanied by the shedding of magnetic particles; the starting point of the development of the latter corrosion-resistant magnet lies in the assumption that the insufficient corrosion resistance immediately above a grain boundary phase of the magnet surface might be one cause thereof. The surface of an R—Fe—B based sintered magnet is not uniform, and mainly includes a main phase (R₂Fe₁₄B phase) and a grain boundary phase (R-rich phase). It is known that the main phase has relatively stable corrosion resistance, whereas the grain boundary phase has lower corrosion resistance as compared with the main phase, and it was presumed that one cause of the shedding of magnetic particles after a corrosion resistance test might be that the elution of R of the grain boundary phase from the magnet surface cannot be effectively prevented. Then, various studies were made based on a consideration that if the surface of an R—Fe—B based sintered magnet was homogenized first, and a chemical conversion film was then formed, adverse effects of the grain boundary phase of the magnet surface on corrosion resistance would be avoided. As a result, it was found that a heat treatment of a magnet at a predetermined temperature range homogenizes the surface of the magnet, and by subsequently forming a chemical conversion film having a laminate structure including at least an inner layer that contains R, fluorine, and oxygen as constituent elements and an outer layer that is amorphous and contains Zr, Fe, and oxygen as constituent elements (provided that no phosphorus is contained in the film), the magnet can be provided with excellent corrosion resistance.

The heat treatment of the magnet to be treated is preferably performed at a temperature range of 450° C. to 900° C., for example. When the heat treatment is performed at this temperature range, R of the grain boundary phase exudes from the magnet surface, and a layer made of a compound containing R and oxygen (e.g., R oxide such as Nd₂O₃), which is expected to be produced by a reaction of R with oxygen gas present in the treatment atmosphere, is formed in the magnet surface as a heat-treatment layer. As a result, the entire surface can be efficiently homogenized. Usually, such a layer has an R content of 10 at % to 75 at % and an oxygen content of 5 at % to 70 at %. The layer preferably has a thickness of 100 nm to 500 nm. This is because when the layer is too thin, it may be difficult to avoid adverse effects of the grain boundary phase of the magnet surface on corrosion resistance, while when the layer is too thick, productivity may be reduced. In the heat treatment, when a large amount of oxygen gas is present in the treatment atmosphere, this may cause the corrosion of the magnet. Therefore, it is preferable to perform the treatment in an atmosphere where an amount of oxygen gas is reduced, such as in a vacuum of about 1 Pa to about 10 Pa or in an atmosphere of an inert gas such as argon gas. The treatment time is usually 5 minutes to 40 hours. According to an ordinary magnet production process, the magnet to be treated has been previously aged for imparting desired magnetic characteristics thereto. However, when the heat treatment in this embodiment is performed to also achieve the purpose of aging, the aging to be performed prior to the surface working for adjustment to a shape of a predetermined size can be omitted.

The chemical conversion film of the corrosion-resistant magnet of the present invention is firmly in close contact with the surface of the R—Fe—B based sintered magnet, and thus exhibits sufficient corrosion resistance when the thickness thereof is 10 nm or more. The upper limit of the thickness of the chemical conversion film is not limited. However, for demands based on the miniaturization of a magnet itself and in terms of production cost, the thickness is preferably 200 nm or less, and more preferably 150 nm or less.

As mentioned above, in the case where no special artificial pre-processing is performed, the surface of the magnet on which a chemical conversion film is to be formed includes a main phase (R₂Fe₁₄B phase) and a grain boundary phase (R-rich phase) (90% or more of the surface area is the main phase) and is not uniform. Meanwhile, in the case where the above-mentioned heat treatment is performed, the surface of the magnet is made of a uniform heat-treatment layer. These variations in the magnet surface composition lead to the difference in the details of the structure of the chemical conversion film formed thereon. However, the common point is that the film has a laminate structure including at least an inner layer that contains R, fluorine, and oxygen as constituent elements and an outer layer that is amorphous and contains Zr, Fe, and oxygen as constituent elements (provided that no phosphorus is contained in the film). The inner layer usually has an R content of 3 at % to 70 at %, a fluorine content of 1 at % to 20 at %, and an oxygen content of 3 at % to 60 at %. The inner layer is formed by the etching effect of fluorine contained in the treatment liquid on the surface of the magnet, and it is presumed that together with R that is a constituent element of the magnet, fluorine forms a chemically stable R fluoride (NdF₃, etc.), for example, contributing to the corrosion resistance of the chemical conversion film (in particular, it is believed that on the grain boundary phase, the R fluoride thus formed is present to cover the grain boundary phase, thereby preventing the shedding of magnetic particles or the cracking of the magnet). It is also presumed that R forms a chemically stable R oxide (Nd₂O₃, etc.) together with oxygen, for example, contributing to the corrosion resistance of the chemical conversion film. The inner layer may further contain Fe as a constituent element. In the case where no special artificial pre-processing is performed, the inner layer of the chemical conversion film formed on the grain boundary phase has an Fe content of less than 15 at %, while the inner layer of the chemical conversion film formed on the main phase has an Fe content of 50 at % or more, which is extremely high (the upper limit is approximately 75 at %). It is presumed that Fe contained in the inner layer of the chemical conversion film formed on the main phase forms a chemically stable Fe oxide (FeO, etc.) together with oxygen, for example, contributing to the corrosion resistance of the chemical conversion film. In terms of the contribution of the inner layer to the corrosion resistance of the chemical conversion film, productivity, and the like, it is preferable that the inner layer has a thickness of 2 nm to 70 nm. The outer layer usually has a Zr content of 5 at % to 60 at %, an Fe content of 1 at % to 20 at %, and an oxygen content of 30 at % to 90 at %. Examples of Zr-containing compounds include Zr oxides with excellent corrosion resistance, and it is presumed that the presence of a Zr oxide contributes to the corrosion resistance of the chemical conversion film. It is also presumed that Fe contained in the outer layer forms a chemically stable Fe oxide (FeO, etc.) together with oxygen, for example, contributing to the corrosion resistance of the chemical conversion film. The outer layer may further contain R as a constituent element. Usually, the R content of the outer layer of the chemical conversion film formed on the main phase and the grain boundary phase and the R content of the outer layer of the chemical conversion film formed on the heat-treatment layer are both 0.5 at % to 5 at %. However, the latter tends to be slightly lower than the former. In terms of the contribution of the outer layer to the corrosion resistance of the chemical conversion film, productivity, and the like, it is preferable that the outer layer has a thickness of 5 nm to 100 nm.

The chemical conversion film formed on the surface of the magnet may further contain another layer in addition to the inner layer and the outer layer. For example, in the case where a chemical conversion film is formed on the surface of a magnet to be treated without any special artificial pre-processing of the magnet, the chemical conversion film formed on the main phase may include an intermediate layer between the inner layer and the outer layer, which has a higher R content than the inner layer and the outer layer. This intermediate layer has an R content of 10 at % to 50 at %, and it is characterized in that R in the film accumulates in the center of the film. This intermediate layer has an oxygen content as high as 10 at % to 70 at %, and this leads to presumption that R contained in this intermediate layer forms a chemically stable R oxide (Nd₂O₃, etc.) together with oxygen, for example, contributing to the corrosion resistance of the chemical conversion film. In terms of the contribution of this intermediate layer to the corrosion resistance of the chemical conversion film, productivity, and the like, it is preferable that this intermediate layer has a thickness of 3 nm to 50 nm. The chemical conversion film formed on the main phase may also have, as an intermediate layer different from the intermediate layer mentioned above, an intermediate layer having a high Fe content (20 at % to 70 at %) and a high oxygen content (5 at % to 40 at %). It is presumed that Fe contained in this intermediate layer forms a chemically stable Fe oxide (FeO, etc.) together with oxygen, for example, contributing to the corrosion resistance of the chemical conversion film. In terms of the contribution of this intermediate layer to the corrosion resistance of the chemical conversion film, productivity, and the like, it is preferable that this intermediate layer has a thickness of 1 nm to 25 nm. The chemical conversion film formed on the grain boundary phase may have, between the inner layer and the outer layer, as an intermediate layer, a layer having an R content at least twice that of the outer layer. This layer causes strong halation as observed under a transmission electron microscope and thus has insulating property, and it is presumed that this characteristic also contributes to the corrosion resistance of the chemical conversion film. In terms of the contribution of this intermediate layer to the corrosion resistance of the chemical conversion film, productivity, and the like, it is preferable that this intermediate layer has a thickness of 1 nm to 20 nm.

Incidentally, the inner and outer layers of the chemical conversion film may each contain other constituent elements in addition to the constituent elements mentioned above, and it is also possible that an intermediate layer other than the intermediate layers mentioned above is present between the inner layer and the outer layer (provided that no phosphorus is contained in the film).

Significant advantages of a corrosion-resistant magnet obtained by subjecting a magnet to be treated to the heat treatment mentioned above and then forming a chemical conversion film on the surface thereof are as follows. A heat-treatment layer formed in the magnet surface by the heat treatment of the magnet (layer made of a compound containing R and oxygen) is provided with a uniform and adequate oxygen content; as a result, a chemical conversion film with excellent corrosion resistance can be formed on the surface thereof, and, in addition, the strength of adhesion with other materials after the formation of the chemical conversion film can be improved. Such effects are attributed to that a layer deteriorated by processing, which includes small cracks or distortion caused in the magnet surface by a surface working or the like, is repaired by the heat treatment, and also that a dense heat-treatment layer that withstands stress on the interface between the chemical conversion film and the magnet homogenizes the entire magnet surface. The oxygen content of the heat-treatment layer is preferably 8 at % to 50 at %, and more preferably 15 at % to 45 at %. When the oxygen content is less than 8 at %, a heat-treatment layer that sufficiently repairs the layer deteriorated by processing may not be formed, while when the oxygen content is more than 50 at %, the heat-treatment layer may be embrittled, whereby adhesion strength will not be improved (even when the oxygen content is less than 8 at % or more than 50 at %, such an oxygen content itself does not adversely affect the formation of a chemical conversion film with excellent corrosion resistance). An example of a simple method for providing the heat-treatment layer with a uniform and adequate oxygen content is a method in which the magnet to be treated is housed in a heat-resistant box made of a metal such as molybdenum (preferably a box that includes a case body with an open top and a lid, and is configured to allow outside air to pass between the case body and the lid), and then subjected to a heat treatment. By using such a method, the magnet to be treated can be protected from the direct effects of a temperature increase in the heat treatment apparatus or differences in the atmosphere. As a result, a heat-treatment layer having a uniform and adequate oxygen content can be formed in the magnet surface.

The rare-earth element (R) in the R—Fe—B based sintered magnet used in the present invention includes at least Nd. The rare-earth element (R) may also include at least one of Pr, Dy, Ho, Tb, and Sm, and may further include at least one of La, Ce, Gd, Er, Eu, Tm, Yb, Lu, and Y. Although a single kind of R is usually sufficient, in practical application, a mixture of two or more kinds (misch metal, didym, etc.) may also be used for the reason of availability. With respect to the R content of the R—Fe—B based sintered magnet, when it is less than 10 at %, the crystal structure is a cubic crystal structure that is the same as α-Fe, and, therefore, high magnetic characteristics, particularly high magnetic coercive force (H_{cj}), cannot be obtained. Meanwhile, when it is more than 30 at %, this results in an increased amount of an R-rich non-magnetic phase, reducing the residual magnetic flux density (Bᵣ), whereby a permanent magnet with excellent characteristics cannot be obtained. Accordingly, the R content is preferably 10 at % to 30 at % of the composition.

With respect to the Fe content, when it is less than 65 at %, the Br decreases, while when it is more than 80 at %, high H_{cj} cannot be obtained. Accordingly, the Fe content is preferably 65 at % to 80 at %. Further, by substituting a part of Fe with Co, the temperature characteristics of the resulting magnet can be improved without impairing its magnetic characteristics. However, when the Co substitution amount is more than 20 at % of Fe, the magnetic characteristics are degraded, and this thus is undesirable. A Co substitution amount of 5 at % to 15 at % leads to a higher Bᵣ than in the case where substitution is not performed, and this thus is desirable in order to obtain a high magnetic flux density.

With respect to the B content, when it is less than 2 at %, the R₂Fe₁₄B phase, which is the main phase, decreases, and high H_{cj} cannot be obtained, while when it is more than 28 at %, this results in an increased amount of a B-rich non-magnetic phase, whereby the Bᵣ decreases, and a permanent magnet with excellent characteristics cannot be obtained. Accordingly, the B content is preferably 2 at % to 28 at %. In order to improve the magnet productivity or reduce the price, the magnet may contain at least one of P and S in a total amount of 2.0 wt % or less. Further, a part of B may be substituted with C in an amount of 30 wt % or less so as to improve the corrosion resistance of the magnet.

Further, the addition of at least one of Al, Ti, V, Cr, Mn, Bi, Nb, Ta, Mo, W, Sb, Ge, Sn, Zr, Ni, Si, Zn, Hf, and Ga is effective in improving magnetic coercive force or the squareness of the demagnetization curve, improving productivity, and reducing the price. In addition to R, Fe, B, and other elements that can be contained, the R—Fe—B based sintered magnet may also contain impurities inevitable in the industrial production.

In addition, another corrosion-resistant film may further be laminated and formed on the surface of the chemical conversion film of the present invention. Such a configuration makes it possible to enhance/complement the characteristics of the chemical conversion film of the present invention or impart further functionalities. The chemical conversion film of the present invention has excellent adherence with a resin film, and, therefore, by forming a resin film on the surface of the chemical conversion film, the magnet can be provided with even higher corrosion resistance. When the magnet has a ring shape, in order to form a uniform film, it is preferable that the formation of a resin film on the surface of the chemical conversion film is performed by electrodeposition coating. A specific example of the electrodeposition coating of a resin film is epoxy resin based cationic electrodeposition coating.

### EXAMPLES

Hereinafter, the present invention will be described in detail with reference to the examples, but the following descriptions are not to be construed as restrictive.

### Example 1

An alloy flake of a composition of 17Nd-1Pr-75Fe-7B (at %) with a thickness of 0.2 mm to 0.3 mm was produced by strip casting. Next, this alloy flake was packed into a container, and housed in a hydrotreating apparatus. The inside of the hydrotreating apparatus was then filled with hydrogen gas at a pressure of 500 kPa, whereby hydrogen was absorbed by the alloy flake at room temperature and then released. The alloy flake was embrittled by this hydrotreatment, forming an amorphous powder with a size of about 0.15 mm to about 0.2 mm. To the coarse grinding powder thus obtained was added 0.04 mass % of zinc stearate as a grinding aid, followed by mixing. A grinding process was then carried out using a jet milling apparatus to produce a fine powder having an average powder particle size of about 3 μm. Using a pressing machine, the fine powder thus obtained was formed into a powder compact. Specifically, pressing was performed by compressing the powder particles in an applied magnetic field with the magnetic field being oriented. Subsequently, the compact was removed from the pressing machine, subjected to a sintering process in a vacuum furnace at 1050° C. for 4 hours, and then aged at 500° C. for 3 hours to form a sintered block. This sintered block was mechanically surface-worked to give a sintered magnet with a size of length: 13 mm×width: 7 mm×thickness: 1 mm.

Ten such magnets were housed in a cage, and immersed in a 470 L bath overflowing with deionized water. Ultrasonic water cleaning was performed for 1 minute using a 1200 W immersion ultrasonic transducer while maintaining a cycle in which the cage was oscillated up and down at an amplitude of 5 cm in the liquid bath, with the oscillation being stopped for 5 seconds at each of the upper and lower end positions. Subsequently, the cage housing the magnet was immersed in a 500 L bath filled with a treatment liquid (trade name: PALLUCID 1000, manufactured by Nihon Parkerizing Co., Ltd.), which was prepared by dissolving 23.8 kg of PALLUCID 1000MA and 8.3 kg of AD-4990 in deionized water to a total volume of 475 L and adjusting the pH to 3.6 with an ammonium salt. A cycle in which the cage was oscillated up and down at an amplitude of 5 cm in the liquid bath, with the oscillation being stopped for 5 seconds at each of the upper and lower end positions, was maintained, and a chemical conversion treatment was thus performed for 5 minutes. Incidentally, the treatment liquid had a bath temperature of 55° C., and was constantly stirred using a magnet pump (200 V, 0.2 kW: manufactured by Sanso Electric Co., Ltd.). The magnet was pulled up from the treatment liquid, then washed with water for 1 minute, and further washed with hot water at 60° C. for 1 minute. After washing, water droplets on the surface of the magnet were removed with an air blower, and a drying treatment was performed at 160° C. for 35 minutes, thereby forming a chemical conversion film with a thickness of about 100 nm on the surface of the magnet.

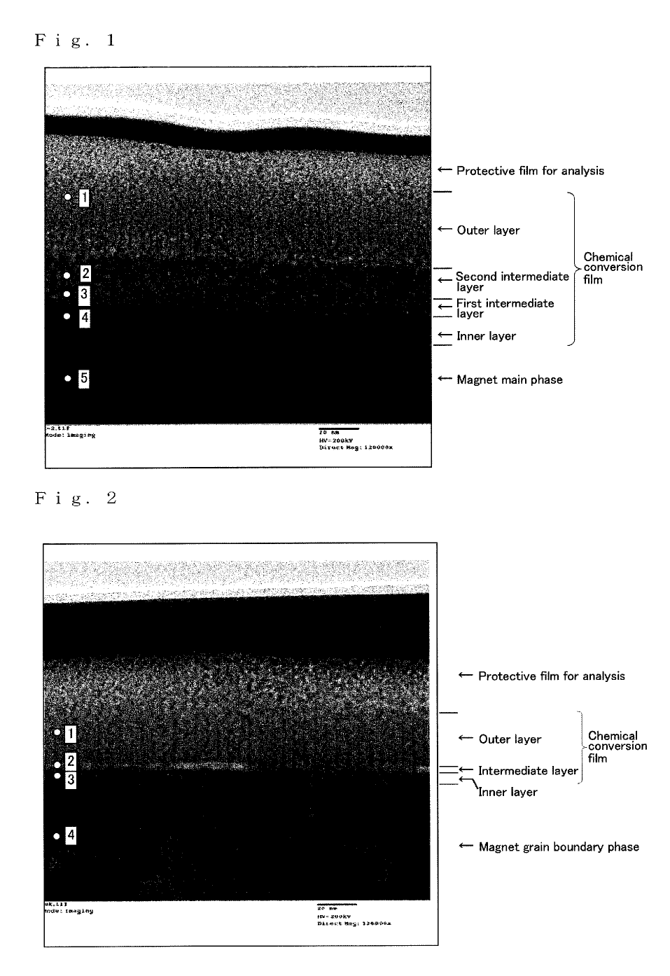

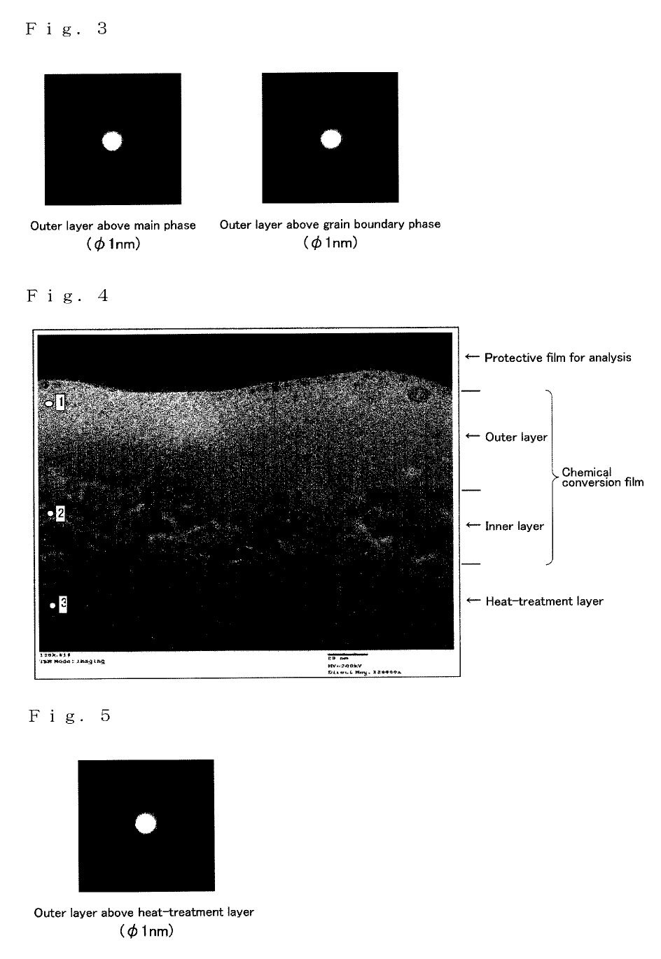

The magnet thus obtained having a chemical conversion film on the surface thereof was embedded in resin and polished, and a sample was produced using an ion beam cross-section polisher (SM09010: manufactured by JEOL Ltd.). Using a transmission electron microscope (HF2100: manufactured by Hitachi High-Technologies Corporation), the cross-section above the main phase and also the cross-section above the grain boundary phase (triple point) were observed. FIG. 1 shows a photograph of the cross-section above the main phase, and FIG. 2 shows a photograph of the cross-section above the grain boundary phase. In addition, the composition above the main phase and the composition above the grain boundary phase analyzed using an energy dispersive X-ray analyzer (EDX: VOYAGER III manufactured by NORAN Instruments Inc.) are shown in Table 1 and Table 2, respectively. As is obvious from FIG. 1 and Table 1, it was shown that the chemical conversion film formed on the main phase has a laminate structure made of the following four layers from the surface of the magnet toward the outer surface: an inner layer with a thickness of 10 nm to 20 nm containing R (Nd and Pr: the same applies hereinafter), a large amount of Fe, oxygen, and fluorine; a first intermediate layer with a thickness of 5 nm to 10 nm having nearly the same composition as the inner layer except that almost no fluorine was contained; a second intermediate layer with a thickness of 20 nm to 30 nm characterized by having the highest R content; and an outer layer with a thickness of 40 nm to 60 nm containing Zr, R, Fe, and oxygen. In addition, as is obvious from FIG. 2 and Table 2, it was shown that the chemical conversion film formed on the grain boundary phase has a laminate structure made of the following three layers from the surface of the magnet toward the outer surface: an inner layer with a thickness of 5 nm to 15 nm containing R, a small amount of Fe, oxygen, and fluorine; an intermediate layer with a thickness of 3 nm to 5 nm containing Zr, R, Fe, and oxygen; and an outer layer with a thickness of 30 nm to 40 nm containing not less than twice the amount of Zr as in the intermediate layer, not more than half the amount of R as in the intermediate layer, Fe, and oxygen. Incidentally, as a result of electron diffraction, the outer layer of the chemical conversion film formed on the main phase and the outer layer of the chemical conversion film formed on the grain boundary phase both formed a halo pattern, showing that they were both amorphous (see FIG. 3).

TABLE 1

| Above | | | | | | | |
|---|---|---|---|---|---|---|---|
| Main Phase | Zr | Nd | Pr | Fe | O | F | Remarks |
| Point 1 | 35.2 | 1.7 | 0.5 | 13.3 | 49.4 | | Outer Layer |
| Point 2 | | 19.1 | 3.2 | 24.0 | 53.7 | | Second Inter- |
| | | | | | | | mediate Layer |
| Point 3 | | 7.7 | 2.0 | 62.5 | 27.9 | | First Inter- |
| | | | | | | | mediate Layer |
| Point 4 | | 4.6 | 0.8 | 61.3 | 24.4 | 8.9 | Inner Layer |
| Point 5 | | 6.1 | 1.4 | 82.3 | 10.2 | | Magnet Main |
| | | | | | | | Phase |

Unit: at % (blank indicates a value of less than 0.1 at %)

TABLE 2

| Above Grain | | | | | | | |
|---|---|---|---|---|---|---|---|
| Boundary Phase | Zr | Nd | Pr | Fe | O | F | Remarks |
| Point 1 | 49.7 | 1.8 | 0.6 | 2.7 | 45.1 | | Outer Layer |
| Point 2 | 16.9 | 12.6 | 4.6 | 6.4 | 59.6 | | Intermediate |
| | | | | | | | Layer |
| Point 3 | | 25.7 | 8.2 | 0.4 | 55.4 | 10.3 | Inner Layer |
| Point 4 | | 41.6 | 14.4 | 2.5 | 41.4 | | Magnet Grain |
| | | | | | | | Boundary Phase |

Unit: at % (blank indicates a value of less than 0.1 at %)

### Example 2

Using a radial ring sintered magnet of the same composition as the sintered magnet of Example 1 with a size of outer diameter: 39 mm×inner diameter: 33 mm×length: 9 mm, a chemical conversion film with a thickness of about 100 nm was formed on the surface of the magnet in the same manner as in Example 1. The magnet thus obtained having a chemical conversion film on the surface thereof was subjected to a pressure cooker test for 24 hours under the following conditions: temperature: 125° C., relative humidity: 100%, pressure: 2 atm. Subsequently, shed particles were removed using a tape. The magnet was weighed before and after the test to determine the shed amount. As a result, the shed amount was 3.0 g/m².

### Comparative Example 1

The same magnet as the radial ring sintered magnet of Example 2 was subjected to ultrasonic water cleaning for 1 minute in the same manner as in Example 1. Subsequently, a cage housing the magnet was immersed in a 500 L bath filled with a treatment liquid prepared by dissolving 3.6 kg of phosphoric acid in deionized water to a total volume of 475 L and adjusting the pH to 2.9 with sodium hydroxide, and a chemical conversion treatment was performed in the same manner as in Example 1, except that the bath temperature of the treatment liquid was 60° C. Washing and a drying treatment were then performed to form a chemical conversion film with a thickness of about 100 nm on the surface of the magnet. The magnet thus obtained having a chemical conversion film on the surface thereof was subjected to a pressure cooker test in the same manner as in Example 2, and the shed amount was determined. As a result, the shed amount was 7.0 g/m², which was larger than the shed amount in Example 2.

### Comparative Example 2

The same magnet as the radial ring sintered magnet of Example 2 was subjected to ultrasonic water cleaning for 1 minute in the same manner as in Example 1. Subsequently, a cage housing the magnet was immersed in a 500 L bath filled with a treatment liquid prepared by dissolving 3.3 kg of chromic acid in deionized water to a total volume of 475 L, and a chemical conversion treatment was performed in the same manner as in Example 1, except that the bath temperature of the treatment liquid was 60° C. and the chemical conversion treatment time was 10 minutes. Washing and a drying treatment were then performed to form a chemical conversion film with a thickness of about 100 nm on the surface of the magnet. The magnet thus obtained having a chemical conversion film on the surface thereof was subjected to a pressure cooker test in the same manner as in Example 2, and the shed amount was determined. As a result, the shed amount was 6.0 g/m², which was larger than the shed amount in Example 2.

### Example 3

POWERNICS (product name, manufactured by Nippon Paint Co., Ltd.) was electrodeposited on the magnet obtained in Example 2 having a chemical conversion film on the surface thereof (epoxy resin based cationic electrodeposition coating, conditions: 200 V, 150 seconds), followed by baking and drying at 195° C. for 60 minutes, thereby forming an epoxy resin film with a thickness of 20 μm on the surface of the chemical conversion film. The magnet thus obtained having a chemical conversion film and a resin film on the surface thereof was subjected to a pressure cooker test for 48 hours under the following conditions: temperature: 120° C., relative humidity: 100%, pressure: 2 atm. As a result, no abnormalities were observed in the appearance.

### Comparative Example 3

Using the magnet obtained in Comparative Example 1 having a chemical conversion film on the surface thereof, a resin film with a thickness of 20 μm was formed on the surface of the chemical conversion film in the same manner as in Example 3, and a pressure cooker test was performed in the same manner as in Example 3. As a result, blisters were observed in the surface of the resin film.

### Example 4

A sintered magnet of a composition of 17Nd-1Pr-75Fe-7B (at %) with a size of length: 13 mm×width: 7 mm×thickness: 1 mm produced in the same manner as in Example 1 was subjected to a heat treatment in vacuum (2 Pa) at 570° C. for 3 hours→460° C. for 6 hours. The surface of the magnet before the heat treatment and the surface of the magnet after the heat treatment were observed under a field emission scanning electron microscope (FE-SEM: 5800 manufactured by Hitachi High-Technologies Corporation). The observation showed that as a result of the heat treatment of the magnet, the difference between the main phase and the grain boundary phase of the magnet surface was no longer recognized, and the magnet surface was covered with a uniform compound layer and thus homogenized. As a result of the depth profile analysis of the magnet after the heat treatment by Auger spectroscopy (PHI/680 manufactured by ULVAC-PHI, INCORPORATED was used as the apparatus; for the analysis, one side of the magnet used with a size of 13 mm×7 mm was lapped with diamond), the layer formed in the magnet surface was at least 150 nm thick and had a high R content of 35 at % to 38 at % and a high oxygen content of 55 at % to 60 at %, showing that this layer was made of a compound containing these elements (e.g., Nd₂O₃).

Next, the magnet thus heat-treated was subjected to a chemical conversion treatment in the same manner as in Example 1, followed by washing and a drying treatment, thereby forming a chemical conversion film with a thickness of about 100 nm on the surface of the magnet. The magnet thus obtained having a chemical conversion film on the surface thereof was embedded in resin and polished, and a sample was produced using an ion beam cross-section polisher (SM09010: manufactured by JEOL Ltd.). Using a transmission electron microscope (HF2100: manufactured by Hitachi High-Technologies Corporation), the cross-section above the heat-treatment layer was observed. FIG. 4 shows a photograph of the cross-section. In addition, the composition above the heat-treatment layer analyzed using an energy dispersive X-ray analyzer (EDX: VOYAGER III manufactured by NORAN Instruments Inc.) is shown in Table 3. As is obvious from FIG. 4 and Table 3, it was shown that the chemical conversion film formed on the heat-treatment layer has a laminate structure made of the following two layers from the surface of the magnet toward the outer surface: an inner layer with a thickness of 20 nm to 50 nm containing R, Fe, oxygen, and fluorine; and an outer layer with a thickness of 50 nm to 90 nm containing Zr, a small amount of R, Fe, and oxygen. Incidentally, as a result of electron diffraction, the outer layer of the chemical conversion film formed on the heat-treatment layer formed a halo pattern, showing that it was amorphous (see FIG. 5).

TABLE 3

| Above Heat- | | | | | | | |
|---|---|---|---|---|---|---|---|
| Treatment Layer | Zr | Nd | Pr | Fe | O | F | Remarks |
| Point 1 | 10.0 | 0.3 | 0.2 | 2.4 | 87.1 | | Outer Layer |
| Point 2 | | 36.7 | 9.4 | 5.0 | 35.5 | 13.4 | Inner Layer |
| Point 3 | | 33.6 | 7.6 | 16.4 | 42.3 | | Heat-Treat- |
| | | | | | | | ment Layer |

Unit: at % (blank indicates a value of less than 0.1 at %)

### Example 5

A chemical conversion film with a thickness of about 100 nm was formed on the surface of a magnet in the same manner as in Example 4, except that without performing aging prior to the surface working in the production of the magnet, the heat treatment after the surface working was performed to also achieve the purpose of aging. The same results as in Example 4 were obtained.

### Example 6

Using a radial ring sintered magnet of the same composition as the sintered magnet of Example 4 with a size of outer diameter: 39 mm×inner diameter: 32 mm×length: 10 mm, a chemical conversion film with a thickness of about 100 nm was formed on the surface of the magnet in the same manner as in Example 5. The magnet thus obtained having a chemical conversion film on the surface thereof was subjected to a pressure cooker test for 48 hours under the following conditions: temperature: 120° C., relative humidity: 100%, pressure: 2 atm. Subsequently, shed particles were removed using a tape. The magnet was weighed before and after the test to determine the shed amount. As a result, the shed amount was 0.2 g/m², which was significantly small.

### Comparative Example 4

Using the same magnet as the radial ring sintered magnet of Example 6, a chemical conversion treatment was performed in the same manner as in Comparative Example 1, followed by washing and a drying treatment, thereby forming a chemical conversion film with a thickness of about 100 nm on the surface of the magnet. The magnet thus obtained having a chemical conversion film on the surface thereof was subjected to a pressure cooker test in the same manner as in Example 6, and the shed amount was determined. As a result, the shed amount was 2.8 g/m², which was larger than the shed amount in Example 6.

### Comparative Example 5

Using the same magnet as the radial ring sintered magnet of Example 6, a chemical conversion treatment was performed in the same manner as in Comparative Example 2, followed by washing and a drying treatment, thereby forming a chemical conversion film with a thickness of about 100 nm on the surface of the magnet. The magnet thus obtained having a chemical conversion film on the surface thereof was subjected to a pressure cooker test in the same manner as in Example 6, and the shed amount was determined. As a result, the shed amount was 2.1 g/m², which was larger than the shed amount in Example 6.

### Example 7

Using a polar anisotropic ring sintered magnet of the same composition as the sintered magnet of Example 4 with a size of outer diameter: 8 mm×inner diameter: 4 mm×length: 12 mm, a chemical conversion film with a thickness of about 100 nm was formed on the surface of the magnet in the same manner as in Example 4. The magnet thus obtained having a chemical conversion film on the surface thereof was subjected to a pressure cooker test in the same manner as in Example 6, and the shed amount was determined. As a result, the shed amount was as small as 0.45 g/m².

### Example 8

POWERNICS (product name, manufactured by Nippon Paint Co., Ltd.) was electrodeposited on the magnet obtained in Example 6 having a chemical conversion film on the surface thereof (epoxy resin based cationic electrodeposition coating, conditions: 200 V, 150 seconds), followed by baking and drying at 195° C. for 60 minutes, thereby forming an epoxy resin film with a thickness of 20 μm on the surface of the chemical conversion film. The magnet thus obtained having a chemical conversion film and a resin film on the surface thereof was subjected to a pressure cooker test for 72 hours under the same conditions as in Example 6. As a result, no abnormalities were observed in the appearance.

### Comparative Example 6

Using the magnet obtained in Comparative Example 4 having a chemical conversion film on the surface thereof, a resin film with a thickness of 20 μm was formed on the surface of the chemical conversion film in the same manner as in Example 8, and a pressure cooker test was performed for 72 hours under the same conditions as in Example 6. As a result, blisters were observed in the surface of the resin film.

### Example 9

A radial ring sintered magnet of a composition of 11Nd-1Dy-32r-78Fe-1Co-6B (at %) with a size of outer diameter: 34 mm×inner diameter: 28 mm×length: 45 mm produced in the same manner as in Example 1 was arranged and housed in a box made of molybdenum with a size of length: 30 cm×width: 20 cm×height: 10 cm (including a case body with an open top and a lid, and configured to allow outside air to pass between the case body and the lid), and then subjected to a heat treatment in the same manner as in Example 4. The surface of the magnet after the heat treatment showed no fluctuations in the appearance and had a uniform, dark finish. The observation of the surface of the magnet under a field emission scanning electron microscope (FE-SEM: 5800 manufactured by Hitachi High-Technologies Corporation) showed that the surface was covered with a uniform layer and thus homogenized. The oxygen content of the heat-treatment layer measured using an energy dispersive X-ray analyzer (EDX: Genesis 2000 manufactured by EDAX Inc.) was about 30 at %. Subsequently, a chemical conversion film with a thickness of about 100 nm was formed on the surface of the magnet in the same manner as in Example 4. The magnet thus obtained having a chemical conversion film on the surface thereof was immersed in ethanol and then ultrasonically cleaned for 3 minutes, and a silicone based adhesive (SE1750: manufactured by Dow Corning Toray Co., Ltd.) was applied to the entire inner peripheral surface thereof. Also, the same silicone based adhesive was applied to the entire outer peripheral surface of a rotor core (diameter: 27.85 mm×length: 50 mm, material: SS400) obtained by immersing an iron core in acetone, followed by ultrasonic cleaning for 3 minutes. The rotor core was inserted into the inner diameter portion of the magnet, then subjected to a heat treatment in air at 150° C. for 1.5 hours, and allowed to stand at room temperature for 60 hours, thereby giving an adhesion body made of the magnet and the rotor core with a 75 μm thick adhesive layer. This adhesion body was allowed to stand in a high-temperature, high-humidity environment with a temperature of 85° C. and a relative humidity of 85% RH, and the shear strength after standing for 250 hours and the shear strength after standing for 500 hours were compared with the shear strength of the adhesion body before standing in the high-temperature, high-humidity environment (the shear test was performed using UTM-1-5000C manufactured by Toyo Baldwin Co., Ltd.). As a result, while the shear strength before standing in the high-temperature, high-humidity environment was 3.5 MPa, the shear strength after standing for 250 hours and the shear strength after standing for 500 hours were both 3.1 MPa. It was thus shown that although there was a decrease from the shear strength before standing in the high-temperature, high-humidity environment, the shear strength was still high. Incidentally, separations between the magnet and the rotor core were all due to the cohesive failure of the adhesive.

### Example 10

A chemical conversion film with a thickness of about 50 nm was formed on the surface of a magnet in the same manner as in Example 1, except that a treatment liquid prepared by adjusting the pH to 4.0 was used and a chemical conversion treatment was performed for 2 minutes. With respect to the magnet thus obtained having a chemical conversion film on the surface thereof, the chemical conversion film formed on the main phase and the chemical conversion film formed on the grain boundary phase were analyzed in the same manner as in Example 1. The results are shown in Table 4 and Table 5, respectively. As is obvious from Table 4 and Table 5, the chemical conversion film formed on the main phase has a four-layer laminate structure, while the chemical conversion film formed on the grain boundary phase has a three-layer laminate structure. It was thus shown that the laminate structures were the same as those of the chemical conversion film formed on the surface of the magnet in Example 1.

TABLE 4

| | Thickness | | | | | | |
|---|---|---|---|---|---|---|---|
| | (nm) | Zr | Nd | Pr | Fe | O | F |
| Outer Layer | 5 to 15 | 46.3 | 2.6 | 0.7 | 5.5 | 44.8 | |
| (Amorphous) | | | | | | | |
| Second Intermediate | 11 to 21 | | 39.4 | 6.4 | 29.9 | 24.3 | |
| Layer | | | | | | | |
| First Intermediate | 5 to 15 | | 26.7 | 8.0 | 43.6 | 5.6 | 16.1 |
| Layer | | | | | | | |
| Inner Layer | 9 to 19 | | 6.9 | 0.5 | 70.4 | 3.7 | 18.4 |
| Magnet Main Phase | — | | 5.6 | 1.3 | 89.3 | 3.7 | |

Unit: at % (blank indicates a value of less than 0.1 at %)

| | Thickness | | | | | | |
|---|---|---|---|---|---|---|---|
| | (nm) | Zr | Nd | Pr | Fe | O | F |
| Outer Layer | 5 to 13 | 45.8 | 2.9 | 1.1 | 5.9 | 44.3 | |
| (Amorphous) | | | | | | | |
| Intermediate Layer | 3 to 7 | 54.4 | 21.0 | 5.6 | 17.1 | 1.9 | |
| Inner Layer | 8 to 18 | | 49.3 | 11.2 | 9.0 | 18.7 | 11.9 |
| Magnet Grain | — | | 54.7 | 15.0 | 6.0 | 24.3 | |
| Boundary Phase | | | | | | | |

Unit: at % (blank indicates a value of less than 0.1 at %)

### Example 11

A chemical conversion film with a thickness of about 60 nm was formed on the surface of a magnet in the same manner as in Example 1, except that a treatment liquid prepared by adjusting the pH to 4.0 was used and a chemical conversion treatment was performed for 7 minutes. With respect to the magnet thus obtained having a chemical conversion film on the surface thereof, the chemical conversion film formed on the main phase and the chemical conversion film formed on the grain boundary phase were analyzed in the same manner as in Example 1. The results are shown in Table 6 and Table 7, respectively. As is obvious from Table 6 and Table 7, the chemical conversion film formed on the main phase has a four-layer laminate structure, while the chemical conversion film formed on the grain boundary phase has a three-layer laminate structure. It was thus shown that the laminate structures were the same as those of the chemical conversion film formed on the surface of the magnet in Example 1.

TABLE 6

| | Thickness | | | | | | |
|---|---|---|---|---|---|---|---|
| | (nm) | Zr | Nd | Pr | Fe | O | F |
| Outer Layer | 11 to 21 | 40.1 | 1.8 | 0.4 | 11.1 | 46.7 | |
| (Amorphous) | | | | | | | |
| Second Intermediate | 11 to 21 | | 31.2 | 5.6 | 40.7 | 22.4 | |
| Layer | | | | | | | |
| First Intermediate | 13 to 23 | | 19.7 | 2.9 | 62.5 | 14.9 | |
| Layer | | | | | | | |
| Inner Layer | 5 to 15 | | 5.6 | 0.7 | 61.6 | 13.1 | 19.0 |
| Magnet Main Phase | — | | 6.6 | 1.1 | 83.0 | 9.3 | |

Unit: at % (blank indicates a value of less than 0.1 at %)

TABLE 7

| | Thickness | | | | | | |
|---|---|---|---|---|---|---|---|
| | (nm) | Zr | Nd | Pr | Fe | O | F |
| Outer Layer | 15 to 25 | 49.9 | 1.1 | 0.3 | 6.8 | 41.9 | |
| (Amorphous) | | | | | | | |
| Intermediate Layer | 5 to 15 | 55.3 | 15.2 | 4.6 | 21.2 | 3.7 | |
| Inner Layer | 15 to 25 | | 36.4 | 11.5 | 8.8 | 24.3 | 19.0 |
| Magnet Grain | — | | 51.4 | 14.5 | 6.0 | 28.0 | |
| Boundary Phase | | | | | | | |

Unit: at % (blank indicates a value of less than 0.1 at %)

### Example 12

Using the same magnet as the radial ring sintered magnet of Example 2, a chemical conversion treatment was performed in the same manner as in Example 10, thereby forming a chemical conversion film with a thickness of about 50 nm on the surface of the magnet. The magnet thus obtained having a chemical conversion film on the surface thereof was subjected to a pressure cooker test in the same manner as in Example 2, and the shed amount was determined. As a result, the shed amount was 3.3 g/m².

### Example 13

Using the same magnet as the radial ring sintered magnet of Example 2, a chemical conversion treatment was performed in the same manner as in Example 11, thereby forming a chemical conversion film with a thickness of about 60 nm on the surface of the magnet. The magnet thus obtained having a chemical conversion film on the surface thereof was subjected to a pressure cooker test in the same manner as in Example 2, and the shed amount was determined. As a result, the shed amount was 2.8 g/m².

### Example 14

A chemical conversion film with a thickness of about 40 nm was formed on the surface of a magnet in the same manner as in Example 4, except that without performing aging prior to the surface working in the production of the magnet, the heat treatment after the surface working was performed to also achieve the purpose of aging, and that a treatment liquid prepared by adjusting the pH to 4.0 was used and a chemical conversion treatment was performed for 2 minutes. With respect to the magnet thus obtained having a chemical conversion film on the surface thereof, the chemical conversion film formed on the heat-treatment layer was analyzed in the same manner as in Example 4. The result is shown in Table 8. As is obvious from Table 8, the chemical conversion film formed on the heat-treatment layer has a two-layer laminate structure. It was thus shown that the laminate structure was the same as that of the chemical conversion film formed on the surface of the magnet in Example 4.

TABLE 8

| | Thickness | | | | | | |
|---|---|---|---|---|---|---|---|
| | (nm) | Zr | Nd | Pr | Fe | O | F |
| Outer Layer | 5 to 15 | 52.6 | 2.6 | 0.5 | 2.3 | 41.9 | |
| (Amorphous) | | | | | | | |
| Inner Layer | 25 to 35 | | 59.8 | 8.2 | 10.8 | 11.2 | 10.0 |
| Heat-Treatment | — | | 56.7 | 16.2 | 10.4 | 16.8 | |
| Layer | | | | | | | |

Unit: at % (blank indicates a value of less than 0.1 at %)

### Example 15

A chemical conversion film with a thickness of about 50 nm was formed on the surface of a magnet in the same manner as in Example 4, except that without performing aging prior to the surface working in the production of the magnet, the heat treatment after the surface working was performed to also achieve the purpose of aging, and that a treatment liquid prepared by adjusting the pH to 4.0 was used and a chemical conversion treatment was performed for 7 minutes. With respect to the magnet thus obtained having a chemical conversion film on the surface thereof, the chemical conversion film formed on the heat-treatment layer was analyzed in the same manner as in Example 4. The result is shown in Table 9. As is obvious from Table 9, the chemical conversion film formed on the heat-treatment layer has a two-layer laminate structure. It was thus shown that the laminate structure was the same as that of the chemical conversion film formed on the surface of the magnet in Example 4.

TABLE 9

| | Thickness | | | | | | |
|---|---|---|---|---|---|---|---|
| | (nm) | Zr | Nd | Pr | Fe | O | F |
| Outer Layer | 20 to 30 | 58.0 | 1.3 | 0.2 | 3.1 | 37.3 | |
| (Amorphous) | | | | | | | |
| Inner Layer | 20 to 30 | | 48.0 | 10.4 | 5.7 | 20.5 | 15.3 |
| Heat-Treatment | — | | 50.7 | 11.8 | 11.3 | 26.1 | |
| Layer | | | | | | | |

Unit: at % (blank indicates a value of less than 0.1 at %)

### Example 16

Using the same magnet as the radial ring sintered magnet of Example 6, a chemical conversion treatment was performed in the same manner as in Example 14, thereby forming a chemical conversion film with a thickness of about 40 nm on the surface of the magnet. The magnet thus obtained having a chemical conversion film on the surface thereof was subjected to a pressure cooker test in the same manner as in Example 6, and the shed amount was determined. As a result, the shed amount was 0.3 g/m².

### Example 17

Using the same magnet as the radial ring sintered magnet of Example 6, a chemical conversion treatment was performed in the same manner as in Example 15, thereby forming a chemical conversion film with a thickness of about 50 nm on the surface of the magnet. The magnet thus obtained having a chemical conversion film on the surface thereof was subjected to a pressure cooker test in the same manner as in Example 6, and the shed amount was determined. As a result, the shed amount was 0.2 g/m².

### INDUSTRIAL APPLICABILITY

According to the present invention, an R—Fe—B based sintered magnet having on a surface thereof a chemical conversion film with higher corrosion resistance than a conventional chemical conversion film such as a phosphate film can be provided, as well as a method for producing the same. In this respect, the present invention is industrially applicable.

1. A corrosion-resistant magnet characterized by comprising a chemical conversion film on a surface of an R—Fe—B based sintered magnet wherein R is a rare-earth element including at least Nd, the chemical conversion film having a laminate structure including at least an inner layer that contains R, fluorine, and oxygen as constituent elements and an outer layer that is amorphous and contains Zr, Fe, and oxygen as constituent elements, provided that no phosphorus is contained in the film.

2. A corrosion-resistant magnet according to claim 1, characterized in that the inner layer has a fluorine content of 1 at % to 20 at %.

3. A corrosion-resistant magnet according to claim 1, characterized in that the outer layer has a Zr content of 5 at % to 60 at %.

4. A corrosion-resistant magnet according to claim 1, characterized in that the inner layer further contains Fe as a constituent element.

5. A corrosion-resistant magnet according to claim 1, characterized in that the outer layer further contains R as a constituent element.

6. A corrosion-resistant magnet according to claim 1, characterized in that the chemical conversion film has a thickness of 10 nm to 200 nm.

7. A corrosion-resistant magnet according to claim 1, characterized in that the inner layer has a thickness of 2 nm to 70 nm.

8. A corrosion-resistant magnet according to claim 1, characterized in that the outer layer has a thickness of 5 nm to 100 nm.

9. A corrosion-resistant magnet according to claim 1, characterized by containing an intermediate layer between the inner layer and the outer layer.

10. A corrosion-resistant magnet according to claim 1, characterized by having a resin film on a surface of the chemical conversion film.

11. A corrosion-resistant magnet according to claim 1, characterized in that the surface of the magnet has a layer made of a compound containing R and oxygen.

12. A method for producing a corrosion-resistant magnet, characterized in that a chemical conversion film is formed on a surface of an R—Fe—B based sintered magnet wherein R is a rare-earth element including at least Nd, the chemical conversion film having a laminate structure including at least an inner layer that contains R, fluorine, and oxygen as constituent elements and an outer layer that is amorphous and contains Zr, Fe, and oxygen as constituent elements, provided that no phosphorus is contained in the film.

13. A production method according to claim 12, characterized in that the magnet is immersed in an aqueous solution containing at least Zr and fluorine, and the magnet is oscillated up and down and/or from side to side in the solution.

14. A production method according to claim 12, characterized in that the magnet is subjected to a heat treatment at a temperature range of 450° C. to 900° C., and the chemical conversion film is formed thereafter.

15. A production method according to claim 14, characterized in that the heat treatment is performed with the magnet being housed in a heat-resistant box.
